(19) United States
(12) Patent Application Publication
(10) Pub. No.: US 2007/0242003 A1
(43) Pub. Date: Oct. 18, 2007

(54) DEVICE AND METHOD FOR CONTROLLING AN ORGANIC LIGHT-EMITTING DIODE

(76) Inventors: Uwe VOGEL, Dresden (DE); Gerd Bunk, Dresden (DE); Andreas Heinig, Dresden (DE)

Correspondence Address: GLENN PATENT GROUP, 3475 EDISON WAY, SUITE L, MENLO PARK, CA, 94025, US

(21) Appl. No.: 11/697,216

(22) Filed: Apr. 5, 2007

Related U.S. Application Data
(63) Continuation of application No. PCT/EP04/11177, filed on Oct. 6, 2004.

(51) Int. Cl. G09G 3/30

(52) U.S. Cl. 345/76

(57) ABSTRACT

A device for controlling an organic light-emitting diode having a normal operating mode and an adjusting mode has a driver for providing a control current in the normal operating mode; and an adjusting current in the adjusting mode. In addition, the device for controlling has a measuring sensor for detecting a forward voltage applied to the OLED in the adjusting mode, and an adjuster for adjusting the control current in dependence on the detected forward voltage in accordance with an adjusting device.

### CROSS-REFERENCE TO RELATED APPLICATION

This application is a continuation of copending International Application No. PCT/EP2004/011177, filed Oct. 6, 2004, which designated the United States and was not published in English.

### BACKGROUND OF THE INVENTION

1. Field of the Invention

The present invention relates to a device and a method for controlling an organic light-emitting diode as may be employed, in particular, for flat-panel displays.

2. Description of the Related Art

On the basis of organic light-emitting diodes OLEDs, novel flat-panel displays exhibiting many advantages may be realized. The advantages of the OLEDs include the possibility of a large-area deposition of the organic light-emitting diodes on various substrates, the self-luminous properties, which enable very thin displays, a high level of independence of the angle of view, and the potentially high efficiency of such displays.

Disadvantages of such displays made of organic light-emitting diodes are problems concerning lifetime, which make themselves felt in terms of decreasing luminosity and efficiency. The lifetime is determined on the basis of the decrease of the luminosity below a certain threshold value.

FIG. 5 shows voltage characteristics III, IV, and light intensity characteristics I, II of an organic light-emitting diode over time. Characteristic II corresponds to an averaging of the values of characteristic I. Characteristic IV corresponds to an averaging of the values of characteristic III. A current flowing through the organic light-emitting diode is kept constant during the time during which characteristics I, II, III, IV are plotted. It may be seen from FIG. 4 that the forward voltages III, IV are increased over time to achieve a constant forward current. It may also be seen that the light intensities I, II are reduced over time at a constant forward current.

Solutions relating to the operation of organic light-emitting diodes have already been known from the prior art. U.S. Pat. No. 6,456,016 describes an operation of a display at low luminosities/currents and a step-by-step reduction of the luminous intensity during the lifetime. U.S. Pat. No. 6,626,717, US 2002 123291 and JP 2002 203672 look into material adjustments for optimizing the lifetime. U.S. Pat. No. 6,414,661 and WO 01/63587 look into controlling the pixel current over the lifetime without regulation, and into detecting the luminosity by means of a camera. US 2003 0048243 looks into adjusting the drive current while detecting the ambient temperature, and WO 03 34389 deals with controlling the pixel current via correction tables. U.S. Pat. No. 6,710,548, EP 1231592 and US 2002 105279 describe integral current determination and tracking of the OLED voltage. U.S. Pat. No. 6,501,230 describes detecting the hours of operation and driver control, and WO 02 082416 describes adapting the voltage over the operating time. WO 01 63587 deals with detecting the luminosity by means of a CCD camera, and current compensation.

The possibilities of operating an OLED which have been described above exhibit the disadvantage that the achievable lifetime of the OLED is still short, and/or that for monitoring and controlling the luminosity, a device is required which is expensive, in technical terms, to realize.

### SUMMARY OF THE INVENTION

It is an object of the present invention to provide a device and a method for controlling an organic light-emitting diode which enable efficient operation of the organic light-emitting diode.

In accordance with a first aspect, the present invention provides a device having a normal operating mode and an adjusting mode for controlling an organic light-emitting diode, having: a driver means configured to provide, in the normal operating mode, a control current and, in the adjusting mode, a predetermined adjusting current to the organic light-emitting diode; a measuring means configured to detect, in the adjusting mode, a forward voltage applied to the organic light-emitting diode; and an adjusting means configured to adjust the control current in dependence on the detected forward voltage in accordance with an adjustment specification.

In accordance with a second aspect, the present invention provides a method having a normal operating mode and an adjusting mode for controlling an organic light-emitting diode, the method having the steps of: providing an adjusting current to the organic light-emitting diode in the adjusting mode; detecting, in the adjusting mode, a forward voltage applied to the organic light-emitting diode; adjusting a control current in dependence on the detected forward voltage in accordance with an adjustment specification; and providing the control current to the organic light-emitting diode in the normal operating mode.

In accordance with a third aspect, the present invention provides a computer program having a program code for performing the above-mentioned method, when the computer program runs on a computer.

The present invention is based on the findings that a decrease in the luminosity and efficiency of an organic light-emitting diode may be compensated for by increasing the control current of the individual OLED pixels in a regulated manner. Due to the regulation described, the forward current does not remain constant over the lifetime of the OLED, but is constantly increased if necessary. This results in an increase in the lifetime, since a respective threshold of luminosity, which defines too weak a luminosity of the OLED, is achieved at a later point in time.

The subject-matter of the present invention is a possibility of delaying the moment in time when the threshold of brightness relevant for the lifetime duration is reached, and thus of improving the lifetime duration, by detecting the forward voltage of an OLED pixel at a known drive current in a manner which is accurate down to the pixel level, and by subsequently regulating the control of the OLED pixel in an electronic manner.

The basis of the present invention is the characteristic, shown in FIG. 5, of an organic light-emitting diode which exhibits a low level of efficiency over its lifetime. In the inventive approach, a current/voltage characteristic over the time of each individual pixel of an OLED display is sensed, stored and evaluated. In a loop which is cycled through intermittently, the control current is adjusted such that the luminosity of the OLEDs remains constant.

Using the inventive approach, the lifetime behavior of OLED displays may be improved. In particular, every single pixel may be evaluated for compensating for a decrease in the luminosity. In addition, lifetime-duration data may be stored internally and may be polled at a later point in time.

In accordance with the present invention, a forward current of an OLED is not kept constant over the lifetime duration, but is increased in order to keep the light intensity of the light-emitting diode constant if possible. In accordance with an embodiment, the light-emitting diode is placed into an adjusting mode in order to adjust the forward current in dependence on a voltage which is applied to the light-emitting diode, and/or drops thereat. By comparing the voltage sensed with a stored voltage characteristic of the light-emitting diode, one can draw conclusions about the luminous intensity, and, accordingly, one can adjust the forward current if the luminous intensity has decreased too much. The adjusting mode may be activated, for example, at each power-up operation of the light-emitting diode or, alternatively, may be activated by a user. The inventive approach enables the extension of the lifetime duration of an OLED until such time as a maximum admissible operating current of the OLED is achieved.

In accordance with a further embodiment, additionally, a temperature of the organic light-emitting diode is sensed, and the forward current is adjusted in dependence on the temperature sensed. This enables a more accurate regulation of the luminous intensity.

### BRIEF DESCRIPTION OF THE DRAWINGS

These and other objects and features of the present invention will become clear from the following description taken in conjunction with the accompanying drawings, in which:

FIG. 1 is a block diagram of a device for controlling in accordance with an embodiment of the present invention;

FIG. 2 is a block diagram of a device for controlling a plurality of organic light-emitting diodes in accordance with a further embodiment of the present invention;

FIG. 3 is a block diagram of a device for controlling in accordance with a further embodiment of the present invention;

FIG. 4 is a flow chart of a method for controlling an organic light-emitting diode in accordance with an embodiment of the present invention; and

FIG. 5 is a characteristic of an organic light-emitting diode in accordance with the prior art.

### DESCRIPTION OF THE PREFERRED EMBODIMENTS

In the following description of the preferred embodiments of the present invention, identical or similar reference numerals will be used for those elements which are depicted in the various drawings and have similar functions, a repeated description of these elements being omitted.

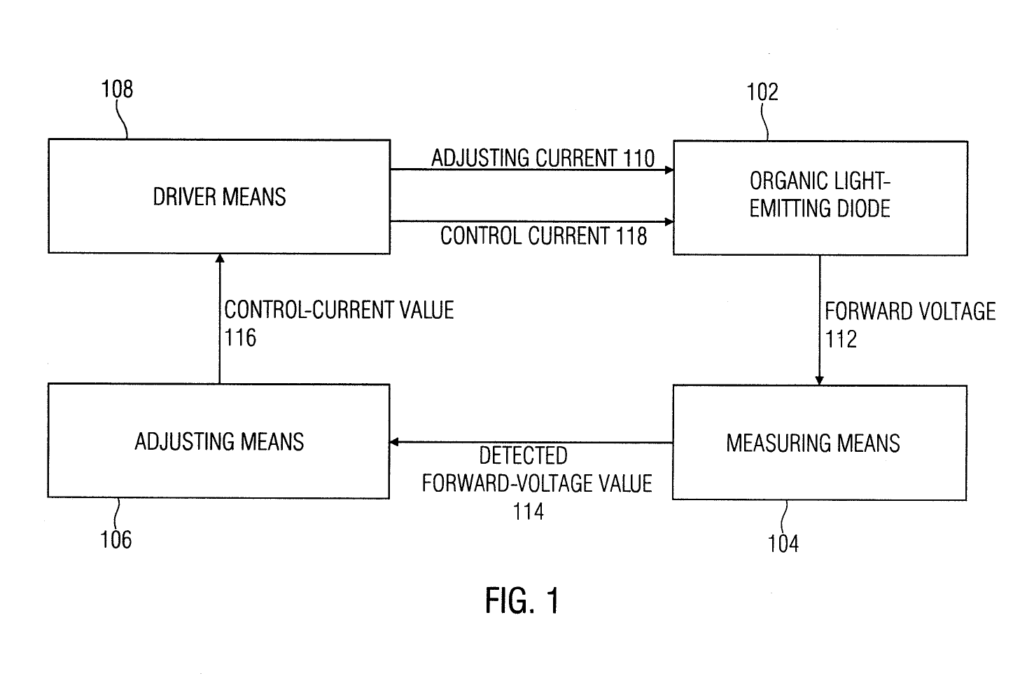

FIG. 1 shows a block diagram of a device for controlling an organic light-emitting diode 102 in accordance with an embodiment of the present invention. The device for controlling comprises a measuring means 104, an adjusting means 106 and a driver means 108. The device for controlling is operable in a normal operating mode and in an adjusting mode.

In the adjusting mode, driver means 108 provides an adjusting current 110 to organic light-emitting diode 102. The adjusting current 110 exhibits a pre-defined value. Measuring means 104 is configured to detect a forward voltage 112 applied to the organic light-emitting diode 102 when the organic light-emitting diode 102 is powered by adjusting current 110. A detected forward-voltage value 114 is provided by measuring means 104 to adjusting means 106. Adjusting means 106 is configured to provide a control-current value 116 to driver means 108 in accordance with an adjustment specification.

In the normal operating mode, driver means 108 provides a control current 118 to organic light-emitting diode 102. Control current 118 is adjusted in accordance with the control-current value 116 provided by adjusting means 106.

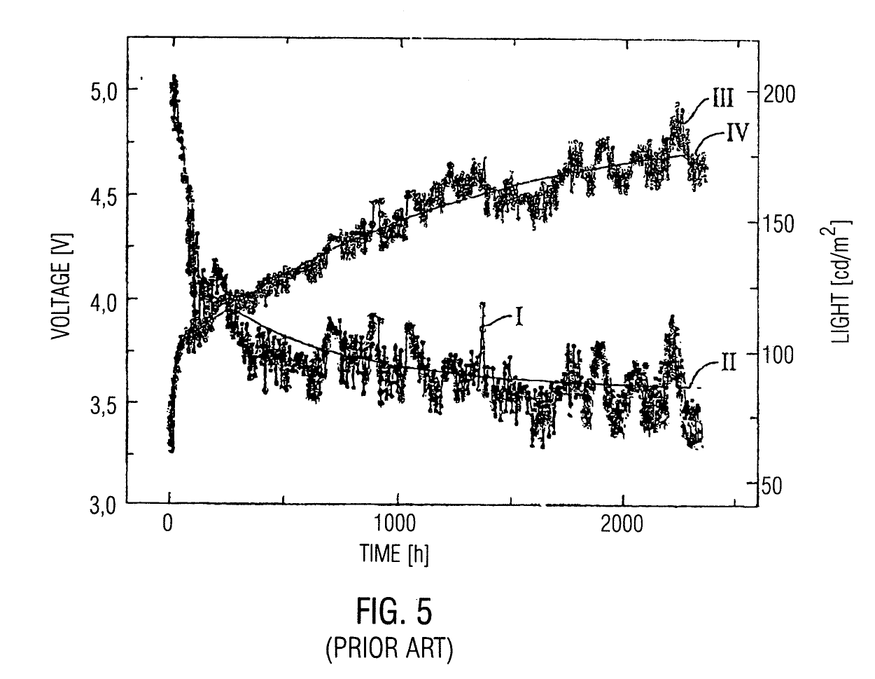

The adjusting mode may be activated periodically, in a user-defined manner or in dependence on an external event. Preferably, a value of the adjusting current 110 is constant at each instance of activation of the adjusting mode. The value of the forward voltage 112 will then depend on the operating time of the organic light-emitting diode 102. A characteristic of the forward voltage 112 over time, at a constant forward current 110, thus corresponds to the characteristics III, IV depicted in FIG. 5. In this embodiment, the characteristic depicted in FIG. 5 is stored in adjusting means 106 and enables a forward-voltage value lying on the voltage characteristic III to be associated with a light intensity value lying on the light-intensity characteristic. Adjusting means 106 is configured to compare the sensed value of forward voltage 114 with the stored voltage characteristics III, IV and to infer a light intensity value associated with the sensed forward voltage 114 from the light-intensity characteristics I, II. In addition, adjusting means 106 is configured to adjust the control-current value 116 in accordance with the determined light intensity of organic light-emitting diode 102. To this end, the light intensity value determined is compared to a predefined threshold value. The control-current value 116 may be increased when the luminous intensity determined falls below the predefined threshold value.

Alternatively, adjusting means 106 may comprise an allocation table from which a differential value for a detected forward-voltage value 114 may be directly obvious, by which differential value a present control-current value 116 must be increased for the light intensity of the OLED to remain constant.

In accordance with an embodiment, adjusting means 106 may be configured to store forward-voltage values 114 sensed. If a newly sensed forward-voltage value 114 does not or only slightly deviate from a forward-voltage value sensed prior to it, control current 118 is not changed.

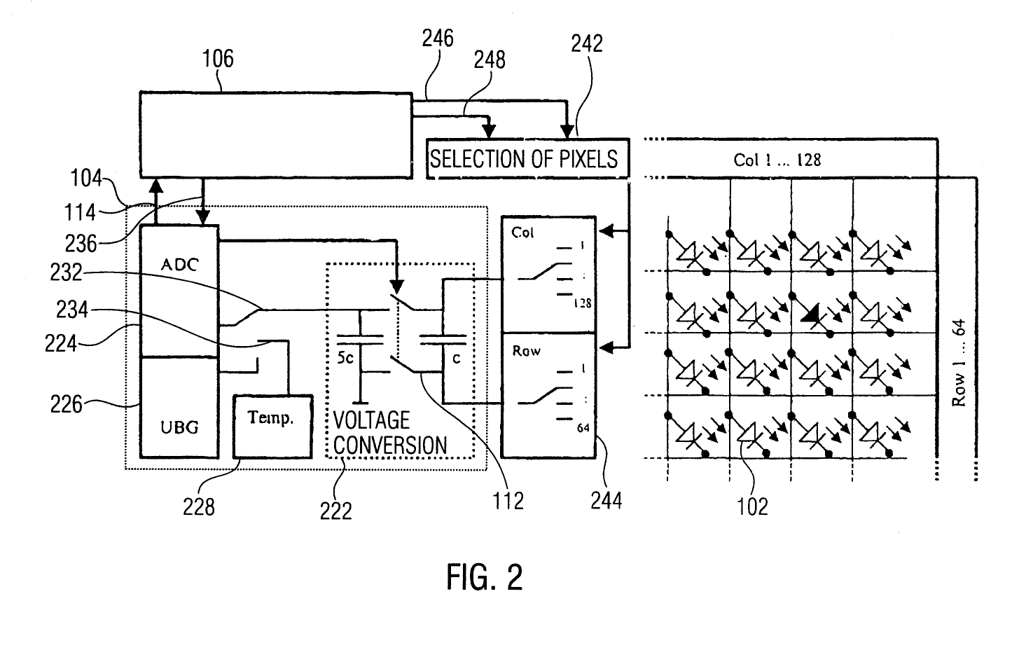

FIG. 2 shows a block diagram of a device for controlling in accordance with a further embodiment of the present invention. In accordance with this embodiment, the device for controlling is configured to control a plurality of organic light-emitting diodes 102 arranged in the manner of a display. In addition to the designated OLED 102, FIG. 2 shows further 15 OLEDs in the display-like arrangement. Measuring means 106 is configured to detect the forward voltage 112 of a selected organic light-emitting diode 102 and provide same as the forward-voltage value 114 to adjusting means 106. A driver means for providing the adjusting current as well as the control current is not shown in FIG. 2 for reasons of clarity. The light-emitting diodes 102 arranged in a display-like manner are contacted via contact lines designated by Col 1 . . . 128 and Row 1 . . . 64. An adjusting current is provided to a selected light-emitting diode 102 during the adjusting mode via a selected pair of contact lines. During the adjusting mode, all the OLEDs of the display-like arrangement are controlled one after the other, and a control-current value 116 is generated for each OLED. If an OLED comprises different subpixels for different primary colors, the individual subpixels may also be controlled during the adjusting mode in an independent manner, and a color-specific control-current value 116 may be generated for the individual subpixels. Advantageously, adjusting means 106 comprises different adjusting characteristics for subpixels of different colors. In the normal operating mode, the pixel-specific control current 118 determined in the adjusting mode is provided to the light-emitting diodes 102 of the display-like arrangement.

Measuring means 104 comprises a voltage conversion means 222, an analog/digital converter 224, a constant voltage source UBG 226, and a temperature sensing means 228. Within the voltage conversion means 222, the high-voltage forward voltage 112 of a selected OLED pixel 102 is transformed to a lower voltage 232 and is fed to the analog/digital converter 224. Voltage conversion means 222 includes a first capacitor C to which forward voltage 112 is applied, and a second capacitor 5C, from which the voltage 232 transformed is tapped off. Temperature sensing means 228 is configured to detect the temperature of the light-emitting diodes 102, or an ambient temperature, and to provide a temperature signal 234 to analog/digital converter 224. Analog/digital converter 224 is configured to sample optionally either the temperature signal 234 or the signal of the voltage 232 transformed. Analog/digital converter 224 is controlled by a control signal 236 of adjusting means 106. Depending on control signal 236, analog/digital converter 224 controls voltage conversion means 222 via a second control signal 238. The digital values of the analog/digital converter then pass to adjusting means 106, which in the present embodiment is a display controller. Adjusting means 106 is configured to store and correct the values obtained from the analog/digital converter. In this embodiment, adjusting means 106 additionally obtains a temperature value sensed from measuring means 104 in addition to the forward voltage 114 detected, due to temperature sensing means 228. This increases the adjusting accuracy for the control current 118, since the luminous intensity of an OLED 102 is dependent on the temperature.

In this embodiment, measuring means 104 is configured to sense, one after the other, forward voltages 112 of the individual diodes 102 of the display during the adjusting mode. To this end, the device for controlling comprises a selection means consisting of a pixel selection means 242 and a multiplexer 244. In accordance with the addressing of a light-emitting diode 102 via a Col line and a Row line, pixel selection means 242 is controlled with a Col selection signal 246 and a Row selection signal 248 from adjusting means 106. A forward voltage of a light-emitting diode 102 selected by pixel selection means 242 is provided to measuring means 104 by multiplexer means 244.

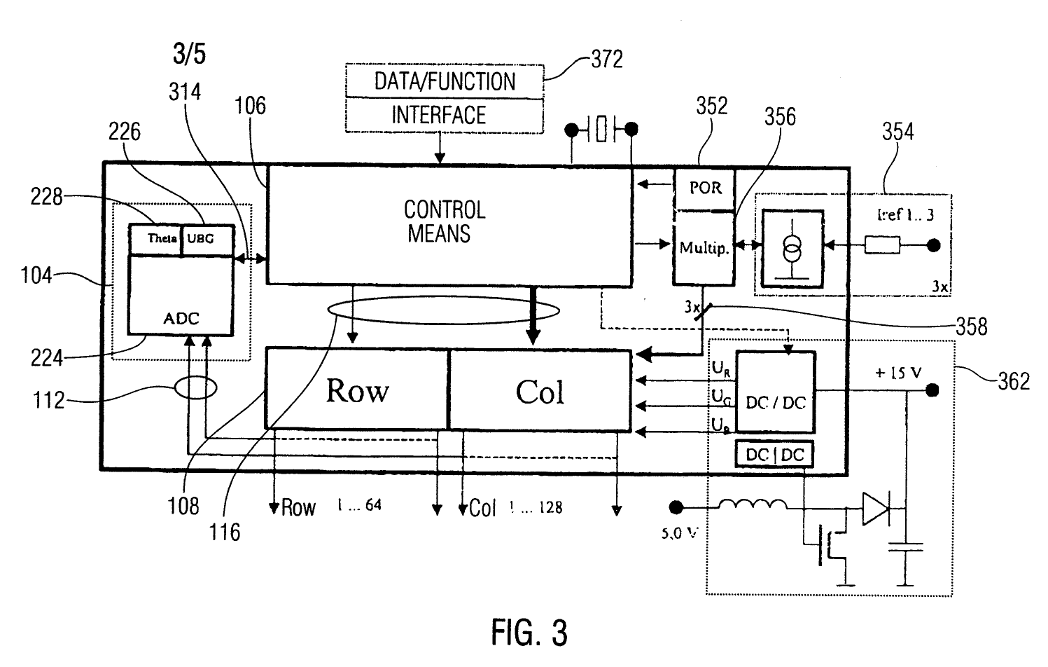

FIG. 3 shows a block diagram of a device for controlling an organic light-emitting diode in accordance with a further embodiment of the present invention. In addition to FIG. 2, FIG. 3 shows the driver means 108 for providing an adjusting current in the adjusting mode, and a control current in the normal operating mode on contacting lines Row 1 . . . 64, Col 1 . . . 128. In this embodiment, control means 106 is connected to a reset means 352 which triggers a power-on reset and provides it to the control means. The power-on reset can be used for activating the adjusting mode. Three reference currents for the three primary colors red, green and blue of the organic light-emitting diodes are provided by a reference current source 354 to a second multiplexer means 356, which is also controlled by control means 106 and provides three multiplexed signals 358 to driver means 106. Three voltages U_{R}, U_{G}, U_{B} are provided to driver means 108 by a voltage source 362. The adjusting means in the form of control means 106 provides the control current 116 to driver means 108.

Analog/digital converter 224, constant-voltage source 226 for providing a reference voltage, and temperature measuring means 228 are diagrammatically shown in FIG. 3 as components of measuring means 104. A forward voltage sensed by the measuring means and/or a temperature are provided, in this embodiment, to adjusting means 106 via a bidirectional signal 314.

In this embodiment, adjusting means 106 comprises an interface 372, via which both data and functional commands may be provided to adjusting means 106. For example, a user may place the device for controlling into the adjusting mode via interface 372.

In addition, data, for example forward-voltage values 114 sensed, temperature values sensed or control-current values 116 determined may be read out from the adjusting means via interface 372.

Additionally, configuration data may be written into adjusting means 106 via interface 372. For example, an original OLED characteristic may be replaced by a new characteristic, or the threshold value for a minimum luminous intensity may be adapted.

In accordance with an embodiment, the adjusting means comprises a mode means (not shown in the figures) configured to place the device for controlling into the adjusting mode in response to an adjustment event, and to place the device for controlling into the normal operating mode in response to an adjustment of the adjusting current. The adjustment event may be the triggering of a reset or of a command of a user.

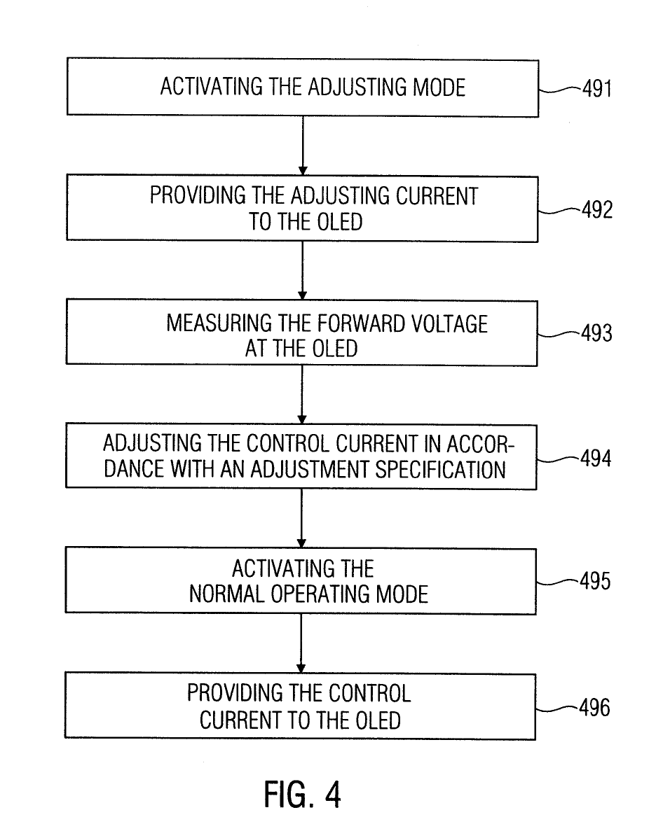

A method for controlling an organic light-emitting diode will be described below with reference to FIG. 4. In a first step 491, the adjusting mode of the device for controlling an organic light-emitting diode is activated. Once the adjusting mode has been activated, the driver means provides the adjusting current to the OLED in a second step 492. In a third step 493, the forward voltage applied to the OLED is measured by the measuring means. In a fifth step 494, the adjusting means adjusts the control-current value of the OLED for the normal operation of the OLED in accordance with an adjustment specification. Once the control current has been adjusted, a sixth step 495 includes activating the normal operating mode of the device for controlling the OLED. The control current adjusted during the adjusting mode is provided to the OLED during the normal operating mode in a seventh step 497.

Here, the control current may represent a maximum drive current for the OLED or, alternatively, a drive current for a desired gray level of the OLED. For color graduation and/or brightness graduation of the OLED, the OLED may also be operated at a smaller drive current during the normal operating mode. Such a smaller drive current, however, orients itself by the most recently determined control current. Thus it is ensured that the brightness may be kept constant over the lifetime duration even with lower brightness stages. A ratio of a currently adjusted control current and the control current adjusted at the original start-up of the OLED may be used as an indication of smaller control currents.

Instead of the control current, control voltage could also be adjusted for controlling the OLED in accordance with the inventive approach.

The devices shown for controlling an organic light-emitting diode enable an increase in the lifetime of OLED displays by regulating the control current. A measured forward voltage of the OLED is employed as a basis of the regulation. The forward voltage is measured via an integrated analog/digital converter. The inventive approach enables selective detection of the voltage-current-time characteristic of each individual pixel. This voltage-current-time characteristic of each individual pixel may be stored in a non-volatile memory (not shown in the figures). On the basis of an algorithm for evaluating the voltage-current-time characteristic, the drive current of the OLED is regulated in normal operation. The algorithm is based on a current-voltage diagram stored in the device for controlling.

The inventive device and/or the inventive method have been described using the example of an organic light-emitting diode. It is obvious that the inventive approach may be employed both for an individual OLED and for a plurality of OLEDs arranged, for example, in a display. In addition, the inventive approach is not limited to organic light-emitting diodes but may be employed for controlling any other elements exhibiting a comparable voltage-current-intensity characteristic.

Depending on the circumstances, the inventive control method may be implemented in hardware or in software. Implementation can be on a digital storage medium, in particular a disk or CD with electronically readable control signals which may interact with a programmable computer system such that the respective method is performed. Generally, the invention thus also consists in a computer program product with a program code, stored on a machine-readable carrier, for performing the inventive method when the computer program product runs on a computer. In other words, the invention may thus be realized as a computer program having a program code for performing the method when the computer program runs on a computer.

While this invention has been described in terms of several preferred embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A device having a normal operating mode and an adjusting mode for controlling an organic light-emitting diode, comprising:
a driver configured to provide, in the normal operating mode, a control current and, in the adjusting mode, a predetermined adjusting current to the organic light-emitting diode;
a measuring sensor configured to detect, in the adjusting mode, a forward voltage applied to the organic light-emitting diode; and
an adjuster configured to adjust the control current in dependence on the detected forward voltage in accordance with an adjustment specification.

2. The device as claimed in claim 1, wherein the adjuster comprises a pre-defined voltage-current characteristic of the organic light-emitting diode, and wherein the adjustment specification is an allocation, pre-defined in accordance with the voltage-current characteristic, of detected forward-voltage values to control-current values.

3. The device as claimed in claim 1, wherein the adjuster additionally comprises a storage configured to store a first detected forward-voltage value of the organic light-emitting diode, and wherein the adjuster is configured to adjust the control current in dependence on a comparison of a second detected forward-voltage value with the stored first detected forward-voltage value.

4. The device as claimed in claim 3, wherein the storage comprises an interface and is configured to provide detected forward-voltage values and control-current values at the interface.

5. The device as claimed in claim 1, further comprising a mode setter configured to place the device for controlling into the adjusting mode in response an adjustment event, and to place the device for controlling into the normal operating mode upon detection of the forward voltage by the measuring sensor.

6. The device as claimed in claim 5, further comprising a resetter configured to place the device for controlling into a defined original state, and wherein the adjustment result consists in placing the device for controlling into the original state.

7. The device as claimed in claim 4, wherein the mode setter is coupled to the interface, and the adjustment event is a mode command triggered by a user.

8. The device as claimed in claim 1, further comprising a detector for temperature detection, the adjuster being configured to further adjust the control current in dependence on a temperature detected by the detector for temperature detection.

9. The device as claimed in claim 1, wherein the measuring sensor comprises an analog/digital converter configured to convert the detected forward voltage into a digital voltage value and provide it to the adjuster.

10. The device as claimed in claim 1, further comprising a multiplexer configured to select a first organic light-emitting diode as the organic OLED from a plurality of organic light-emitting diodes of a display-like arrangement.

11. A method comprising a normal operating mode and an adjusting mode for controlling an organic light-emitting diode, the method comprising:
a) providing an adjusting current to the organic light-emitting diode in the adjusting mode;
b) detecting, in the adjusting mode, a forward voltage applied to the organic light-emitting diode;
c) adjusting a control current in dependence on the detected forward voltage in accordance with an adjustment specification; and
d) providing the control current to the organic light-emitting diode in the normal operating mode.

12. A computer program having a program code for performing the method comprising a normal operating mode and an adjusting mode for controlling an organic light-emitting diode, the method comprising:
a) providing an adjusting current to the organic light-emitting diode in the adjusting mode;
b) detecting, in the adjusting mode, a forward voltage applied to the organic light-emitting diode;
c) adjusting a control current in dependence on the detected forward voltage in accordance with an adjustment specification; and
d) providing the control current to the organic light-emitting diode in the normal operating mode,
when the computer program runs on a computer.

13. A device having a normal operating mode and an adjusting mode for controlling an organic light-emitting diode, comprising:
a driver configured to provide, in the normal operating mode, a control current and, in the adjusting mode, a predetermined adjusting current with a predefined value to the organic light-emitting diode, the predefined value of the adjusting current being constant at each activation of the adjusting mode;
a measuring sensor configured to detect, in the adjusting mode, a forward voltage applied to the organic light-emitting diode; and
an adjuster configured to adjust the control current in dependence on the detected forward voltage in accordance with an adjustment specification,
wherein the adjuster is configured to draw conclusions from a comparison of the detected forward voltage with a characteristic curve of the forward voltage of the organic light-emitting diode over time, at the predetermined adjusting current, on a luminous intensity of the light-emitting diode in the adjusting mode, and, in dependence on the luminous intensity, to set control-current values for the control current.

14. A method comprising a normal operating mode and an adjusting mode for controlling an organic light-emitting diode, the method comprising:
a) providing a predetermined adjusting current with a predefined value to the organic light-emitting diode in the adjusting mode, the predefined value of the adjusting current being constant at each activation of the adjusting mode;
b) detecting, in the adjusting mode, a forward voltage applied to the organic light-emitting diode;
c) adjusting a control current in dependence on the detected forward voltage in accordance with an adjustment specification, by drawing conclusions on a luminous intensity of the light-emitting diode in the adjusting mode by a comparison of the detected forward voltage with a characteristic curve of the forward voltage of the organic light-emitting diode over time, at the predetermined adjusting current, and setting control-current values for the control current; and
d) providing the control current to the organic light-emitting diode in the normal operating mode.
